(19) United States
(12) Patent Application Publication
(10) Pub. No.: US 2022/0011008 A1
(43) Pub. Date: Jan. 13, 2022

(54) WEATHER-RESISTANT PLANT FIBER-REINFORCED AIR DUCT WITH MULTI-LAYER WALL, AND PREPARATION METHOD THEREOF

(71) Applicant: International Center for Bamboo and Rattan, Beijing (CN)

(72) Inventors: Haitao CHENG, Beijing (CN); Wenfu ZHANG, Beijing (CN); Ge WANG, Beijing (CN); Cuicui WANG, Beijing (CN); Shaohua GU, Beijing (CN); Haijun ZHENG, Beijing (CN)

(21) Appl. No.: 16/923,649

(22) Filed: Jul. 8, 2020

(51) Int. Cl. F24F 13/02; B32B 5/26; B32B 15/08; B32B 5/24; B32B 27/38; B32B 7/12

(52) U.S. Cl. CPC F24F 13/0263; B32B 2038/0072; B32B 5/26; B32B 15/08; B32B 5/245; B32B 27/38; B32B 7/12; B32B 2260/023; B32B 2260/046; B32B 2262/06; B32B 2262/101; B32B 2307/712; B32B 2307/7265; B32B 2305/022; F24F 13/0281

(57) ABSTRACT

The disclosure relates to the technical field of air ducts, and in particular to a weather-resistant plant fiber-reinforced air duct with a multi-layer wall, and a preparation method thereof. The weather-resistant plant fiber-reinforced air duct with a multi-layer wall includes an outer isolation layer, a plant fiber-reinforced thermal insulation layer, a moisture-proof layer and a sealing layer that are arranged in sequence from inside to outside. The plant fiber-reinforced thermal insulation layer is prepared by the paving and laminating of surface fiber foam materials and core fiber foam materials or by the winding and molding of glass fibers and plant fibers. An outer isolation layer is adopted to protect the plant fiber-reinforced thermal insulation layer from being damaged by rubbing, and the moisture-proof layer and the sealing layer are adopted to ensure that the air does not leak out.

### TECHNICAL FIELD

The present invention relates to the technical field of air ducts, and in particular to a weather-resistant plant fiber-reinforced air duct with a multi-layer wall, and a preparation method thereof.

### BACKGROUND OF THE INVENTION

At present, the air ducts used in high-rise buildings mainly include: galvanized thin-steel air ducts, fiberglass air ducts, and composite thermal-insulation air ducts. While the galvanized thin-steel air duct has advantages such as high mechanical strength and low cost, a muffler needs to be installed due to the high density, large mass and poor sound insulation effect of the metal material. Moreover, the metal material has poor corrosion resistance, is susceptible to rust, and requires a relatively-complicated construction process. Therefore, the galvanized thin-steel air duct has been gradually eliminated. The fiberglass air duct, which is prefabricated manually with flange connection, has high fire resistance and corrosion resistance, but additional thermal-insulation and noise-reduction layers are required due to its large mass, brittleness and poor thermal-insulation and noise-reduction effects. Moreover, it is challenging to design and install a fiberglass air duct and offer later maintenance, which requires a long construction period. Therefore, the fiberglass air duct is also rarely applied at present. The composite thermal-insulation air duct is easy to be installed and has a high cost-performance ratio, but also has disadvantages, such as large mass, poor thermal-insulation and noise-reduction effects, and air leakage in high-air-pressure use.

### SUMMARY OF THE INVENTION

The present invention is intended to provide a weather-resistant plant fiber-reinforced air duct with a multi-layer wall, and a preparation method thereof. In the present invention, a multi-layer wall and plant fibers are adopted to solve technical difficulties in thermal insulation of air ducts, wind resistance of air duct or the like. The plant fiber can reduce the density of an air duct, increase the strength of an air duct, and improve the anti-vibration and dampening properties of an air duct.

In order to realize the objective of the present invention, the present invention provides the following technical solutions.

The present invention provides a weather-resistant plant fiber-reinforced air duct with a multi-layer wall, including an outer isolation layer, a plant fiber-reinforced thermal insulation layer, a moisture-proof layer and a sealing layer that are arranged in sequence from inside to outside. The plant fiber-reinforced thermal insulation layer is prepared by the paving and laminating of surface fiber foam materials and core fiber foam materials or by the winding and molding of glass fibers and plant fibers. As an example of the present invention, the weather-resistant plant fiber-reinforced air duct with a multi-layer wall has a total thickness preferably of 20 mm to 25 mm.

Preferably, if the plant fiber-reinforced thermal insulation layer is prepared by the winding and molding of glass fibers and plant fibers, the plant fiber-reinforced thermal insulation layer includes a glass fiber-epoxy resin layer, a transition layer and a plant fiber-phenolic resin layer that are arranged in sequence; the transition layer is a glass fiber-epoxy resin and plant fiber-phenolic resin composite layer; and the glass fiber-epoxy resin layer is in contact with the outer isolation layer.

Preferably, the outer isolation layer is aluminium foil cloth, polyethylene cloth or woven geotextile; the moisture-proof layer is polyethylene-polypropylene cloth; and the sealing layer is aluminum foil cloth or glass fiber layer. As an example of the present invention, the outer isolation layer has a thickness preferably of 0.5 mm, the plant fiber-reinforced thermal insulation layer has a thickness preferably of 15 mm to 20 mm; the moisture-proof layer has a thickness preferably of 1 mm, and the sealing layer has a thickness preferably of 0.2 mm.

The present invention provides a method for preparing a weather-resistant plant fiber-reinforced air duct with a multi-layer wall, including any one of method 1 and method 2.

The method 1 includes the following steps: mixing plant fibers with a toughened phenolic foam material at a mass ratio of (25-35):100, and then subjecting the mixture to a first emulsification to obtain a surface fiber foam material; mixing plant fibers with a toughened phenolic foam material at a mass ratio of (5-15):100, and then subjecting the mixture to a second emulsification to obtain a core fiber foam material; paving and laminating the surface fiber foam material and the core fiber foam material, and conducting closed-cell foaming to obtain a plant fiber-reinforced thermal insulation layer;

with the method of paving and laminating, stacking an outer isolation layer, the plant fiber-reinforced thermal insulation layer, a moisture-proof layer and a sealing layer in sequence from bottom to top to obtain a wall material for the weather-resistant plant fiber-reinforced air duct with a multi-layer wall; and assembling the wall material for the weather-resistant plant fiber-reinforced air duct with a multi-layer wall into a square weather-resistant plant fiber-reinforced air duct with a multi-layer wall; where, during the stacking, a coupling agent, vinyl resin and a fiber-based plasticized adhesive are successively coated on the previous layer for the stacking of the next layer; and the square weather-resistant plant fiber-reinforced air duct with a multi-layer wall has the outer isolation layer as an inner wall and the sealing layer as an outer wall;

or with the method of paving and laminating, stacking an outer isolation layer, the plant fiber-reinforced thermal insulation layer, a moisture-proof layer and a sealing layer on a cylindrical mold in sequence from inside to outside to obtain a circular weather-resistant plant fiber-reinforced air duct with a multi-layer wall; where, during the stacking, a coupling agent, vinyl resin and a fiber-based plasticized adhesive are successively coated on the previous layer for the stacking of the next layer.

As an example of the present invention, the coupling agent is preferably silane coupling agent KH172; and the vinyl resin is preferably 3301 bisphenol A-type unsaturated resin. As an example of the present invention, the coupling agent is sprayed at an amount preferably of 2.5%; and the vinyl resin is coated at an amount preferably of 50 g/m².

In the present invention, the surface layer of the plant fiber-reinforced thermal insulation layer has a higher content of plant fiber and the core layer has a lower content of plant fiber, allowing a stronger breakage-resistance; in addition, the closed-cell phenolic foam material of the core layer is more beneficial for thermal insulation. Furthermore, the three layers of the plant fiber-reinforced thermal insulation layer all include plant fibers and phenolic foam materials, with plant-fiber contents in the surface layer, core layer and surface layer changing from low to high and then to low. As the tree layers of the obtained plant fiber-reinforced thermal insulation layer are made of plant fibers and phenolic foam materials that are mixed at varying ratios, the plant fiber-reinforced thermal insulation layer does not tend to be layered. Based on the foam thermal insulation intensified by plant fibers, the toughness of the outer layer and the thermal insulation of the inner layer are further strengthened.

In the present invention, an outer isolation layer, a plant fiber-reinforced thermal insulation layer, a moisture-proof layer and a sealing layer are stacked layer by layer, and a coupling agent, vinyl resin and a fiber-based plasticized adhesive are successively coated for the binding of two layers to achieve the modification treatment among layers and improve the adhesion performance among interfaces.

The method 2 includes the following steps: wrapping an outer isolation layer around the core of an air duct mold;

winding glass fibers impregnated with an epoxy resin system around the surface of the outer isolation layer to form a glass fiber-epoxy resin layer on the outer isolation layer; while glass fibers are wound without interruption, winding plant fibers impregnated with a toughened phenolic foam material around the glass fiber-epoxy resin layer to form a glass fiber-epoxy resin and plant fiber-phenolic resin composite layer; stopping the winding of glass fibers, and winding plant fibers impregnated with a toughened phenolic foam material around the transition layer without interruption to form a plant fiber-phenolic resin layer, and finally to obtain a plant fiber-reinforced thermal insulation layer;

wrapping a moisture-proof layer around the surface of the plant fiber-reinforced thermal insulation layer; and

winding glass fibers impregnated with an epoxy resin system around the moisture-proof layer to form a sealing layer on the surface of the moisture-proof layer.

As an example of the present invention, the glass fiber is an alkali-free glass fiber twisted roving.

In the present invention, an air duct suitable for medium and high pressures can be rapidly prepared by winding and molding, which can effectively improve the sealing performance of the air duct and reduce the air leakage of the air duct. The present invention improves the integrity of an air duct and reinforces the positive-pressure resistance of an air duct by adopting a structure obtained from winding and molding.

As an example of the present invention, in the present invention, the shell of the air duct mold is preferably sleeved outside the sealing layer, and the core of the air duct mold is heated at 90° C. for 25 min. The inside of the core of the air duct mold is heated by the passage of heat transfer oil, so that the heat is transferred from inside to outside. Moreover, the air duct mold is rotated, and the heat is gradually transferred from inside to outside, so that the epoxy resin system in the pre-finished thermal insulation air duct is cured and molded first, and then the toughened phenolic foam material is thermally expanded and adhered to the aluminum foil cloth. After the excess foamed toughened phenolic foam material is extruded from the air duct mold due to the rotation of the air duct mold, the core of the air duct mold is naturally cooled to room temperature, and then the shell and core of the air duct mold are removed. The ends are cut off, and aging is conducted to obtain a weather-resistant plant fiber-reinforced air duct with a multi-layer wall that has a wall thickness of 20 mm. In the air duct mold, the inner diameter of the shell and the outer diameter of the core have a difference of 40 mm.

Preferably, in the method 1, the first emulsification and the second emulsification are carried out independently for 5 s to 10 s under stirring, with a rotational speed independently of 1,500 r/min to 2,000 r/min.

Preferably, in the method 1, the paving and laminating method is as follows: paving the surface fiber foam material to form a lower surface layer, paving the core fiber foam material on the lower surface layer to form a core layer, and paving the surface fiber foam material on the core layer to form an upper surface layer; and the lower surface layer, the core layer and the upper surface layer have a thickness ratio of (1-2):(6-8):(1-2).

Preferably, in the method 1, the fiber-based plasticized adhesive is prepared as follows: grinding a plant fiber material into plant fiber particles with a particle diameter less than 50 μm, and then mixing the plant fiber particles, an antibacterial agent of nano-silver, a film-forming agent of Texanol, a chelating agent of diethylene triamine pentaacetic acid and water at a mass ratio of 100:(5-8):(8-15):(7-12):1,000; stirring the mixture at 500 r/min to 1,000 r/min for 20 min to 30 min, and subjecting the mixture to vacuumization; standing the resulting mixture; and then adjusting the pH to 5.5 to 5.9 to obtain a fiber-based plasticized adhesive. As an example of the present invention, the standing is conducted for 10 min to 20 min.

Preferably, in the method 2, the glass fiber impregnated with an epoxy resin system is wound around the surface of the outer isolation layer, with a winding angle of 53°, a winding tension of 30 N to 50 N and a yarn width of 1 mm to 3 mm.

Preferably, in the method 2, the epoxy resin system has a mass fraction independently of 30% to 40% in the glass fiber-epoxy resin layer and the sealing layer.

Preferably, the epoxy resin system is a mixture of epoxy resin YD127 and curing agent EC201 with a mass ratio of 4:1.

Preferably, in the method 2, the glass fiber and plant fiber are wound into 2 to 3 layers, with a winding angle of 20° to 30°, a winding tension of 20 N and a yarn width of 4 mm to 15 mm.

Preferably, the high-temperature toughened phenolic foam system has a mass fraction of 70% to 75% in the transition layer.

Preferably, the toughened phenolic foam material is prepared as follows: mixing phenol, formaldehyde, furfural or acetaldehyde, hydrochloric acid and modifier at 40° C. to 50° C. for 20 min to 30 min at a mass ratio of 100:(60-70):(20-35):(5-6):(8-12); subjecting the mixture to condensation reaction at 85° C. to 90° C. for 20 min to 30 min, and then adjusting the pH to 7.0 to 7.5 to obtain a modified phenolic resin; and mixing the modified phenolic resin, a surfactant, a compound curing agent, a foaming agent and an adjuvant thoroughly at a mass ratio of 100:(7-9):(10-13):(5-6):(6-8) to obtain a toughened phenolic foam material. As an example of the present invention, the modifier is preferably tung oil, linseed oil or butyronitrile. As an example of the present invention, the modified phenolic resin has a solid mass fraction of 70% to 75%, a viscosity of 3,000 Pa·s, a moisture content ≤15%, and a free phenol content of 3.0 mg/L to 5.0 mg/L.

Preferably, the surfactant is emulsifier OP-10, Tween 80, or a mixture of Tween 80 and emulsifier OP-10 with a mass ratio of 1:1; the foaming agent is petroleum ether, n-pentane, dichloromethane, or a mixture of dichloromethane and petroleum ether with a mass ratio of 1:1; the compound curing agent is a mixture of p-toluenesulfonic acid and phosphoric acid with a mass ratio of 1:(0.5-3); and the adjuvant is polyglycerol.

Preferably, in the method 2, plant fibers impregnated with a toughened phenolic foam material are wound (including continuous winding, pultrusion winding, reciprocating winding) around the transition layer, with a winding angle of 15° to 53°, a winding tension of 10 N to 50 N, and a yarn width of 4 mm to 6 mm; a total of N plant fiber layers are formed by reciprocating winding, with N being 6-12; and during the winding process, after the third plant fiber layer is formed, a total of M circular gasket layers are provided at intervals of one or more plant fiber layers.

The M circular gasket layers are provided as follows: after the third plant fiber layer is formed, a plurality of circular gaskets with ascending outer diameters are sleeved on the third plant fiber layer at equal intervals to form a circular gasket layer; then one or more plant fiber layers are continuously wound around the circular gasket layer; and the circular gasket layer and the plant fiber layer are repeatedly arranged to finally form M circular gasket layers among N plant fiber layers. The circular gaskets in each circular gasket layer are arranged as interleaving with circular gaskets in an adjacent circular gasket layer, and the circular gaskets in each circular gasket layer have outer diameters that gradually increase in the opposite direction to that for circular gaskets in an adjacent circular gasket layer. The outer end surfaces of circular gaskets at the right and left ends in each circular gasket layer are located close to the right and left end surfaces of the mold respectively, but are not flush with the right and left end surfaces. The N and M are natural numbers, with N>M.

Preferably, the material of the circular gasket is honeycomb paper.

Preferably, in the method 2, the glass fiber impregnated with an epoxy resin system is wound around the moisture-proof layer, with a winding angle of 53°, a winding tension of 30 N to 50 N and a yarn width of 1 mm to 3 mm.

The present invention provides a weather-resistant plant fiber-reinforced air duct with a multi-layer wall, including an outer isolation layer, a plant fiber-reinforced thermal insulation layer, a moisture-proof layer and a sealing layer that are arranged in sequence from inside to outside. In the present invention, an outer isolation layer is adopted to protect the plant fiber-reinforced thermal insulation layer from being damaged by rubbing, and the moisture-proof layer and the sealing layer are adopted to ensure that the air does not leak out and the moisture in the air will not diffuse into the plant fiber-reinforced thermal insulation layer under the ventilation of the air duct. The weather-resistant plant fiber-reinforced air duct with a multi-layer wall provided in the present invention has excellent thermal insulation, light weight, high flame-resistance and strong breakage-resistance.

### DETAILED DESCRIPTION OF THE INVENTION

The technical solutions in the present invention will be clearly and completely described below in conjunction with the examples of the present invention. Apparently, the described examples are merely some rather than all of the examples of the present invention. All other examples obtained by a person of ordinary skill in the art based on the examples of the present invention without creative efforts shall fall within the protection scope of the present invention.

### Example 1

Preparation of a toughened phenolic foam material: Phenol, formaldehyde, furfural, hydrochloric acid and modifier were mixed at 40° C. for 30 min at a mass ratio of 100:60:35:6:8; the mixture was subjected to condensation reaction at 90° C. for 20 min, and then the pH was adjusted to 7.0 to obtain a modified phenolic resin; and the modified phenolic resin, a surfactant, a curing agent, a foaming agent and an adjuvant were mixed thoroughly at a mass ratio of 100:9:10:5:6 to obtain a high-temperature toughened phenolic foam system. The modifier was butyronitrile; the surfactant was emulsifier OP-10; the curing agent was p-toluenesulfonic acid; the foaming agent was trichloromethane; the adjuvant was polyether 4110; and the modified phenolic resin had a solid mass fraction of 70%, a viscosity of 3,000 Pa·s, a moisture content ≤15%, and a free phenol content of 3.0 mg/L; bamboo fiber with length less than 3 mm is used as plant fiber.

Preparation of a fiber-based plasticized adhesive: a plant fiber material was ground into plant fiber particles with a particle diameter less than 50 μm, and then the plant fiber particles, an antibacterial agent of nano-silver, a film-forming agent of Texanol, a chelating agent of diethylene triamine pentaacetic acid and water were mixed at a mass ratio of 100:(5-8):(8-15):(7-12):1,000; the mixture was stirred at 500 r/min to 1,000 r/min for 20 min to 30 min and subjected to vacuumization; the resulting mixture stood for 15 min; and then the pH was adjusted to 5.5 to 5.9 to obtain a fiber-based plasticized adhesive; bamboo fiber with length less than 1 mm is used as plant fiber.

Plant fibers were mixed with the toughened phenolic foam material at a mass ratio of 30:100, and then the mixture was subjected to emulsification at 2,000 r/min for 5 s to obtain a surface fiber foam material; plant fibers were mixed with the toughened phenolic foam material at a mass ratio of 12:100, and then the mixture was subjected to emulsification at 2,000 r/min for 5 s to obtain a core fiber foam material; and the surface fiber foam material and the core fiber foam material were paved and laminated to finally obtain a plant fiber-reinforced thermal insulation layer. The paving and laminating method is specifically as follows: the surface fiber foam material was paved to form a lower surface layer, the core fiber foam material was paved on the lower surface layer to form a core layer, and the surface fiber foam material was paved on the core layer to form an upper surface layer. The lower surface layer, the core layer and the upper surface layer had a thickness ratio of 1.5:7:1.5 in the plant fiber-reinforced thermal insulation layer.

With the method of paving and laminating, an outer isolation layer, the plant fiber-reinforced thermal insulation layer, a moisture-proof layer and a sealing layer were stacked in sequence from bottom to top to obtain a wall material for the weather-resistant plant fiber-reinforced air duct with a multi-layer wall; and the wall material for the weather-resistant plant fiber-reinforced air duct with a multi-layer wall was assembled into a square weather-resistant plant fiber-reinforced air duct with a multi-layer wall by adhesion. During the stacking, a coupling agent (silane coupling agent KH172), vinyl resin (3301 bisphenol A-type unsaturated resin) and the fiber-based plasticized adhesive were successively coated on the previous layer for the stacking of the next layer, the coupling agent was sprayed at an amount preferably of 2.5%, and the vinyl resin was coated at an amount preferably of 50 g/m². The square weather-resistant plant fiber-reinforced air duct with a multi-layer wall had the outer isolation layer as an inner wall and the sealing layer as an outer wall. The outer isolation layer was polyethylene; the moisture-proof layer was polyethylene-polypropylene cloth; and the sealing layer was aluminum foil cloth.

The weather-resistant plant fiber-reinforced air duct with a multi-layer wall prepared in this example had the following properties: total thickness: 25 mm; thickness of the plant fiber-reinforced thermal insulation layer: 20 mm; thermal conductivity (w/m·k) of the thermal insulation material: 0.029; combustion performance of the structure/plant fiber-reinforced thermal insulation layer: class B; density (kg/m²) of the composite panel: 8.11; breaking load (N): 1,650; thermal resistance (k/w): 1.11; and heat loss: 6.2%. Use and characteristics: heating and ventilation.

### Example 2

Phenol, formaldehyde, furfural, hydrochloric acid and modifier were mixed at 50° C. for 30 min at a mass ratio of 100:70:20:5:10; the mixture was subjected to condensation reaction at 90° C. for 20 min, and then the pH was adjusted to 7.0 to obtain a modified phenolic resin; and the modified phenolic resin, a surfactant, a curing agent, a foaming agent and an adjuvant were mixed thoroughly at a mass ratio of 100:7:13:5:8 to obtain a toughened phenolic foam material. The modifier was tung oil; the surfactant was Tween 80; the curing agent was p-toluenesulfonic acid; the foaming agent was petroleum ether; the adjuvant was polyether 4110; and the modified phenolic resin had a solid mass fraction of 75%, a viscosity of 3,000 Pa·s, a moisture content ≤14%, and a free phenol content of 5.0 mg/L.

Aluminum foil was manually wrapped around the core of an air duct mold as an outer isolation layer.

The glass fibers were impregnated with an epoxy resin system, and then reciprocally wound around the surface of the outer isolation layer 42 times to form a glass fiber-epoxy resin layer on the outer isolation layer, with a winding angle of 53°, a winding tension of 50 N and a yarn width of 3 mm, where, the epoxy resin system had a mass fraction of 40% in the glass fiber-epoxy resin layer and was a mixture of epoxy resin YD127 and curing agent EC201 with a mass ratio of 4:1; and the glass fiber was an alkali-free glass fiber twisted roving. While the glass fibers were wound without interruption, plant fibers impregnated with the toughened phenolic foam material were reciprocally wound into 3 layers to form a transition layer (glass fiber-epoxy resin and plant fiber-phenolic resin composite layer), with a winding angle of 30°, a winding tension of 20 N and a yarn width of 4 mm, where, the toughened phenolic foam material had a mass fraction of 70% in the transition layer; the plant fiber was a three-strand, 1.5-Nm jute fiber yarn; and the glass fiber was an alkali-free glass fiber twisted roving.

The winding of glass fibers was stopped, and the plant fibers impregnated with the toughened phenolic foam material were reciprocally wound around the transition layer without interruption to obtain a plant fiber-reinforced thermal insulation layer. A total of 6 plant fiber layers were formed by reciprocating winding, with a winding angle of 53°, a winding tension of 50 N, and a yarn width of 6 mm; and during the winding process, after the third plant fiber layer was formed, a total of 3 circular gasket layers were provided on the third plant fiber layer, the fourth plant fiber layer and the fifth plant fiber layer respectively. Each circular gasket in each circular gasket layer had a difference of 0.5 mm to 1 mm between its inner diameter and outer diameter. The circular gasket layers were provided as follows: starting from a position 0.25 m apart from the left end of the mold, 6 circular gaskets with ascending outer diameters were sleeved on the third plant fiber layer at a spacing of 0.5 m to form the first circular gasket layer, where the circular gaskets had outer diameters of 152 mm, 153 mm, 154 mm, 155 mm, 156 mm and 157 mm in sequence from left to right, and then pretreated plant fibers were continuously wound around the first circular gasket layer to form the fourth plant fiber layer; starting from a position 0.5 m apart from the right end of the mold, 5 circular gaskets with ascending outer diameters were sleeved on the fourth plant fiber layer at a spacing of 0.5 m to form the second circular gasket layer, where the circular gaskets had outer diameters of 158 mm, 159 mm, 160 mm, 161 mm and 162 mm in sequence from right to left, and then pretreated plant fibers were continuously wound around the second circular gasket layer to form the fifth plant fiber layer; starting from a position 0.25 m apart from the left end of the mold, 6 circular gaskets with ascending outer diameters were sleeved on the fifth plant fiber layer at a spacing of 0.5 m to form the third circular gasket layer, where the circular gaskets had outer diameters of 162 mm, 163 mm, 164 mm, 165 mm, 166 mm and 167 mm in sequence from left to right, and then pretreated plant fibers were continuously wound around the third circular gasket layer to form the sixth plant fiber layer; and finally, 3 circular gasket layers were formed among the plant fiber layers. The circular gaskets in each circular gasket layer were arranged as interleaving with circular gaskets in an adjacent circular gasket layer, and the circular gaskets in each circular gasket layer had outer diameters that gradually increase in the opposite direction to that for circular gaskets in an adjacent circular gasket layer. The outer end surfaces of circular gaskets at the right and left ends in each circular gasket layer were located close to the right and left end surfaces of the mold respectively, but were not flush with the right and left end surfaces. After the plant fiber layers and the circular gasket layers were arranged, a plant fiber-reinforced thermal insulation layer with a 3D hollow network structure was obtained. The material of the circular gasket was honeycomb paper with a cavernous structure, and the toughened phenolic foam material had a mass fraction of 70% in the thermal insulation layer of the air duct.

A 0.5 mm polyethylene-polypropylene cloth was wrapped around the outer surface of the obtained plant fiber-reinforced thermal insulation layer with a 3D hollow network structure as a moisture-proof layer.

The glass fibers impregnated with an epoxy resin system was reciprocally wound around the moisture-proof layer to form a sealing layer on the surface of the moisture-proof layer, with a winding angle of 53°, a winding tension of 30 N to 50 N and a yarn width of 1 mm to 3 mm, where, the epoxy resin system had a mass fraction of 35% in the sealing layer; the glass fiber was an alkali glass fiber twisted roving or a glass fiber spun yarn; the glass fibers impregnated with an epoxy resin system were reciprocally wound around the moisture-proof layer 42 times; and the epoxy resin system was a mixture of epoxy resin YD127 and curing agent EC201 with a mass ratio of 4:1.

The shell of the air duct mold was sleeved outside the sealing layer, and the core of the air duct mold was heated at 90° C. for 25 min. The inside of the core of the air duct mold was heated by the passage of heat transfer oil, so that the heat was transferred from inside to outside. Moreover, the air duct mold was rotated, and the heat was gradually transferred from inside to outside, so that the epoxy resin system in the pre-finished thermal insulation air duct was cured and molded first, and then the toughened phenolic foam material was thermally expanded and adhered to the aluminum foil cloth. After the excess foamed toughened phenolic foam material was extruded from the air duct mold due to the rotation of the air duct mold, the core of the air duct mold was naturally cooled to room temperature, and then the shell and core of the air duct mold were removed. The ends were cut off, and aging was conducted to obtain a weather-resistant plant fiber-reinforced air duct with a multi-layer wall that has a wall thickness of 20 mm. In the air duct mold, the inner diameter of the shell and the outer diameter of the core had a difference of 40 mm.

The weather-resistant plant fiber-reinforced air duct with a multi-layer wall prepared in this example had the following properties: total thickness: 20 mm; thermal conductivity (w/m·k) of the thermal insulation material: 0.031; combustion performance of the plant fiber-reinforced thermal insulation layer: class B; density: 0.34 g/cm³; longitudinal breaking load: 4,100 N; and air pressure-resistance (positive pressure: 3,000 Pa, and negative pressure: 750 Pa): meeting the requirements for high-pressure air ducts. Moreover, the composite air duct was tested according to the standard JG/258-2018, and the results were as follows: air leakage per unit area: class C; duct wall deformation: class D (JG/T 258-2018, deformation ≤1%); TVOC content: 0.06 mg/m³; no condensation in the air duct; and noise caused by gas transfer in the air duct: 30 dB, reaching the mute level. Use and characteristics: medium and high pressures.

The above descriptions are merely preferred implementations of the present invention. It should be noted that a person of ordinary skill in the art may further make several improvements and modifications without departing from the principle of the present invention, but such improvements and modifications should be deemed as falling within the protection scope of the present invention.

What is claimed is:

1. A weather-resistant plant fiber-reinforced air duct with a multi-layer wall, comprising an outer isolation layer, a plant fiber-reinforced thermal insulation layer, a moisture-proof layer and a sealing layer that are arranged in sequence from inside to outside, wherein the plant fiber-reinforced thermal insulation layer is prepared by the paving and laminating of surface fiber foam materials and core fiber foam materials or by the winding and molding of glass fibers and plant fibers.

2. The weather-resistant plant fiber-reinforced air duct with a multi-layer wall according to claim 1, wherein, if the plant fiber-reinforced thermal insulation layer is prepared by the winding and molding of glass fibers and plant fibers, the plant fiber-reinforced thermal insulation layer comprises a glass fiber-epoxy resin layer, a transition layer and a plant fiber-phenolic resin layer that are arranged in sequence; the transition layer is a glass fiber-epoxy resin and plant fiber-phenolic resin composite layer; and the glass fiber-epoxy resin layer is in contact with the outer isolation layer.

3. The weather-resistant plant fiber-reinforced air duct with a multi-layer wall according to claim 1, wherein the outer isolation layer is aluminium foil cloth, polyethylene cloth or woven geotextile; and the moisture-proof layer is polyethylene-polypropylene cloth; and the sealing layer is aluminum foil cloth or glass fiber layer.

4. A method for preparing a weather-resistant plant fiber-reinforced air duct with a multi-layer wall, wherein the method comprises any one of the following methods:
method 1, comprising the following steps: mixing plant fibers with a toughened phenolic foam material at a mass ratio of (25-35):100, and then subjecting the mixture to a first emulsification to obtain a surface fiber foam material; mixing plant fibers with a toughened phenolic foam material at a mass ratio of (5-15):100, and then subjecting the mixture to a second emulsification to obtain a core fiber foam material; paving and laminating the surface fiber foam material and the core fiber foam material, and conducting closed-cell foaming to obtain a plant fiber-reinforced thermal insulation layer;
with the method of paving and laminating, stacking an outer isolation layer, the plant fiber-reinforced thermal insulation layer, a moisture-proof layer and a sealing layer in sequence from bottom to top to obtain a wall material for the weather-resistant plant fiber-reinforced air duct with a multi-layer wall; and assembling the wall material for the weather-resistant plant fiber-reinforced air duct with a multi-layer wall into a square weather-resistant plant fiber-reinforced air duct with a multi-layer wall; wherein, during the stacking, a coupling agent, vinyl resin and a fiber-based plasticized adhesive are successively coated on the previous layer for the stacking of the next layer; and the square weather-resistant plant fiber-reinforced air duct with a multi-layer wall has the outer isolation layer as an inner wall and the sealing layer as an outer wall;
or with the method of paving and laminating, stacking an outer isolation layer, the plant fiber-reinforced thermal insulation layer, a moisture-proof layer and a sealing layer on a cylindrical mold in sequence from inside to outside to obtain a circular weather-resistant plant fiber-reinforced air duct with a multi-layer wall; wherein, during the stacking, a coupling agent, vinyl resin and a fiber-based plasticized adhesive are successively coated on the previous layer for the stacking of the next layer; and
method 2, comprising the following steps: wrapping an outer isolation layer around the core of an air duct mold;
winding glass fibers impregnated with an epoxy resin system around the surface of the outer isolation layer to form a glass fiber-epoxy resin layer on the outer isolation layer; while glass fibers are wound without interruption, winding plant fibers impregnated with a toughened phenolic foam material around the glass fiber-epoxy resin layer to form a glass fiber-epoxy resin and plant fiber-phenolic resin composite layer; stopping the winding of glass fibers, winding plant fibers impregnated with a toughened phenolic foam material around the transition layer without interruption to form a plant fiber-phenolic resin layer, and conducting closed-cell foaming and finally to obtain a plant fiber-reinforced thermal insulation layer;
wrapping a moisture-proof layer around the surface of the plant fiber-reinforced thermal insulation layer; and
winding glass fibers impregnated with an epoxy resin system around the moisture-proof layer to form a sealing layer on the surface of the moisture-proof layer.

5. The preparation method according to claim 4, wherein, in the method 1, the first emulsification and the second emulsification are carried out independently for 5 s to 10 s under stirring, with a rotational speed independently of 1,500 r/min to 2,000 r/min.

6. The preparation method according to claim 4, wherein, in the method 1, the paving and laminating method is as follows: paving the surface fiber foam material to form a lower surface layer, paving the core fiber foam material on the lower surface layer to form a core layer, and paving the surface fiber foam material on the core layer to form an upper surface layer; and the lower surface layer, the core layer and the upper surface layer have a thickness ratio of (1-2):(6-8):(1-2).

7. The preparation method according to claim 4, wherein, in the method 1, the fiber-based plasticized adhesive is prepared as follows: grinding a plant fiber material into plant fiber particles with a particle diameter less than 50 μm, and then mixing the plant fiber particles, an antibacterial agent of nano-silver, a film-forming agent of Texanol, a chelating agent of diethylene triamine pentaacetic acid and water at a mass ratio of 100:(5-8):(8-15):(7-12):1,000; stirring the mixture at 500 r/min to 1,000 r/min for 20 min to 30 min, and subjecting the mixture to vacuumization; standing the resulting mixture; and then adjusting the pH to 5.5 to 5.9 to obtain a fiber-based plasticized adhesive.

8. The preparation method according to claim 4, wherein, in the method 2, the glass fiber impregnated with an epoxy resin system is wound around the surface of the outer isolation layer, with a winding angle of 53°, a winding tension of 30 N to 50 N and a yarn width of 1 mm to 3 mm.

9. The preparation method according to claim 4, wherein, in the method 2, the epoxy resin system has a mass fraction independently of 30% to 40% in the glass fiber-epoxy resin layer and the sealing layer.

10. The preparation method according to claim 9, wherein, the epoxy resin system is a mixture of epoxy resin YD127 and curing agent EC201 with a mass ratio of 4:1.

11. The preparation method according to claim 4, wherein, in the method 2, the glass fiber and plant fiber are wound into 2 to 3 layers, with a winding angle of 20° to 30°, a winding tension of 20 N and a yarn width of 4 mm to 15 mm.

12. The preparation method according to claim 4, wherein the high-temperature toughened phenolic foam system has a mass fraction of 70% to 75% in the transition layer.

13. The preparation method according to claim 4, wherein the toughened phenolic foam material is prepared as follows: mixing phenol, formaldehyde, furfural or acetaldehyde, hydrochloric acid and modifier at 40° C. to 50° C. for 20 min to 30 min at a mass ratio of 100:(60-70):(20-35):(5-6):(8-12); subjecting the mixture to condensation reaction at 85° C. to 90° C. for 20 min to 30 min, and then adjusting the pH to 7.0 to 7.5 to obtain a modified phenolic resin; and mixing the modified phenolic resin, a surfactant, a compound curing agent, a foaming agent and an adjuvant thoroughly at a mass ratio of 100:(7-9):(10-13):(5-6):(6-8) to obtain a toughened phenolic foam material.

14. The preparation method according to claim 13, wherein the surfactant is emulsifier OP-10, Tween 80, or a mixture of Tween 80 and emulsifier OP-10 with a mass ratio of 1:1; the foaming agent is petroleum ether, n-pentane, dichloromethane, or a mixture of dichloromethane and petroleum ether with a mass ratio of 1:1; the compound curing agent is a mixture of p-toluenesulfonic acid and phosphoric acid with a mass ratio of 1:(0.5-3); and the adjuvant is polyglycerol.

15. The preparation method according to claim 4, wherein, in the method 2, plant fibers impregnated with a toughened phenolic foam material are wound (including continuous winding, pultrusion winding, reciprocating winding) around the transition layer, with a winding angle of 15° to 53°, a winding tension of 10 N to 50 N, and a yarn width of 4 mm to 6 mm; a total of N plant fiber layers are formed by reciprocating winding, with N being 6-12; and during the winding process, after the third plant fiber layer is formed, a total of M circular gasket layers are provided at intervals of one or more plant fiber layers;
the M circular gasket layers are provided as follows: after the third plant fiber layer is formed, a plurality of circular gaskets with ascending outer diameters are sleeved on the third plant fiber layer at equal intervals to form a circular gasket layer; then one or more plant fiber layers are continuously wound around the circular gasket layer; and the circular gasket layer and the plant fiber layer are repeatedly arranged to finally form M circular gasket layers among N plant fiber layers; the circular gaskets in each circular gasket layer are arranged as interleaving with circular gaskets in an adjacent circular gasket layer, and the circular gaskets in each circular gasket layer have outer diameters that gradually increase in the opposite direction to that for circular gaskets in an adjacent circular gasket layer; the outer end surfaces of circular gaskets at the right and left ends in each circular gasket layer are located close to the right and left end surfaces of the mold respectively, but are not flush with the right and left end surfaces; and the N and M are natural numbers, with N>M.

16. The preparation method according to claim 15, wherein the material of the circular gasket is honeycomb paper.

17. The preparation method according to claim 4, wherein, in the method 2, the glass fiber impregnated with an epoxy resin system is wound around the moisture-proof layer, with a winding angle of 53°, a winding tension of 30 N to 50 N and a yarn width of 1 mm to 3 mm.
